(19) United States
(12) Patent Application Publication
(10) Pub. No.: US 2008/0146290 A1
(43) Pub. Date: Jun. 19, 2008

(54) CHANGING A MUTE STATE OF A VOICE CALL FROM A BLUETOOTH HEADSET

(75) Inventors: KRISHNA IYENGAR SREERAM, HYDERABAD (IN); JAMES L. TRACY, CORAL SPRINGS, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/612,384

(22) Filed: Dec. 18, 2006

(51) Int. Cl. H04M 1/05; H04M 1/72

(52) U.S. Cl. 455/569.1; 455/575.2

(57) ABSTRACT

One aspect of the present invention can include a muting method for mobile telephones. The method can include a step of selecting a multifunction selector of a headset during a communication session. A mute toggle request can result that is conveyed to a mobile communication handset. Software within the handset can toggle a mute state for the communication session. In one embodiment, the multifunction selector can be a multifunction selector of a wireless headset. This selector can be overloaded to accept and terminate calls and/or to increase and decrease volume. In one configuration, the multifunction selector can be a laminate switching mechanism, which accepts a swiping and tapping input. For example, swiping a finger along the mechanism in one direction can increase volume, in another direction can decrease volume, and double tapping the mechanism can toggle a mute state.

### BACKGROUND

1. Field of the Invention

The present invention relates to mobile communication headset control using headset selector and, more particularly, to changing a mute state of a voice call from a wireless headset.

2. Description of the Related Art

Wireless headsets have become a popular accessory for mobile telephones. When wearing one of these wireless headsets, a user can engage in a conversation in an unencumbered fashion. This can be a tremendous boon in situations where hands free operation is desirable, such as while driving.

Use of a wireless headset also permits a user to utilize capabilities of a mobile telephone, while keeping the mobile telephone in a safe or otherwise convenient location. For example, a businessman using a wireless headset can keep his/her mobile phone secure inside a briefcase and still receive and participate in telephone calls. In another example, a user wearing a wireless headset can keep an associated Smartphone docked to a computing device and still use its telephone capabilities in locations proximate to the computing device. A user can also routinely plug their phones into an outlet for recharging purposes and still be able to receive and participate in calls, so long as the wireless headset is worn.

Wireless headsets are typically very small electronic devices that can be worn somewhat unobtrusively. Unlike a handset, a user wearing a headset is unable to see various selectors and settings. This greatly limits which controls are available from the headset. Placing too many selectors or features on a headset would result in a bulkier and more obtrusive headset as well as an increased frequency of user selection errors. At present, most manufactures have opted to include a very limited selection of selectors for adjusting volume and for accepting and terminating a call. The selector for accepting and terminating a call is often the same selector referred to as a multifunction selector. The multifunction selector is typically bigger and more centrally located than the volume selectors to make it easier to quickly select without error. Current implementations of wireless headsets do not permit users to mute/unmute calls from the headset.

The following typical user scenario illustrates a shortcoming of wireless headsets lacking mute toggle capabilities. A user can enter a conference room wearing a wireless headset, while leaving a corresponding handset at the user's desk. A meeting in the conference room can concern details of an important client project and meeting participants can be having a heated discussion concerning alternative ways to handle the project. During this meeting, the client can call to provide the user with details that would be helpful for directing the meeting. The user would prefer to listen to the client while muting meeting noise that could include information not suitable for the client to hear. Since this capability is lacking, the user would be forced to silence the meeting room, to leave the meeting room, or to disconnect from the client, any of which can be problematic or at least inconvenient.

### SUMMARY OF THE INVENTION

One aspect of the present invention can include a method for controlling mobile communication device handsets using input provided by a user via a headset. The method can include a step of selecting a multifunction selector of a headset during a communication session. A mute toggle request can result that is conveyed to a mobile telephone handset. Software within the handset can toggle a mute state for the communication session. The multifunction selector can be overloaded to accept and terminate calls. It can also be overloaded to increase and decrease volume. In another embodiment, the multifunction selector can be a laminate switching mechanism, which is a tactile response region that accepts swiping input. For example, swiping a finger along the region in one direction can increase volume, in another direction can decrease volume, and double tapping the region can toggle a mute state.

Another aspect of the present invention can include a mobile telephone system including a headset and a mobile telephone handset. The headset can include a multifunction selector configured to control accepting a call, terminating a call, and adjusting a mute state of a call. In one contemplated configuration, the multifunction selector can be further overloaded to control volume. The mobile telephone handset can be communicatively linked to the headset through a wired or wireless connection. The handset can include software that receives input from the headset, wherein said software adjusts a mute state for a communication session responsive to receiving a user selection of the multifunction selector during the communication session. For example, pressing and releasing the multifunction selector relatively quickly (e.g., a short press) can toggle the mute state. Pressing the multifunction selector for a predefined and longer duration (e.g., a long press) can result in the software terminating the communication session.

Yet another aspect of the present invention can include a different mobile telephone system including a headset and a mobile communication device handset. The headset can include a laminate switching mechanism functioning as a tactile response region for receiving tactile input. The tactile response region can be a region of overloaded functionality, wherein selecting a particular desired function associated with the tactile response region is dependent upon a manner in which a user utilizes the tactile response region. One such manner can include swiping a finger along the region in a particular direction. The mobile telephone handset can be communicatively linked to the headset through a wireless connection, the handset including software that receives input from the headset, wherein said software adjusts a mute state for a communication session responsive to receiving a user input via the tactile response region in a predetermined manner associated with the function that toggles the mute state for the communication session.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system of a mobile communication device which is able to change a mute state of a voice call using a multifunction selector of a headset.

FIG. 2 is a low chart of a method for changing a mute state from a headset in accordance with an embodiment of the inventive arrangements disclosed herein.

FIG. 3 is a flow chart of a method for adding a muting capability to a headset in accordance with an embodiment of the inventive arrangements disclosed herein.

FIG. 4 is a signaling diagram for performing muting actions via a headset in accordance with an embodiment of the inventive arrangements disclosed herein.

### DETAILED DESCRIPTION OF THE INVENTION

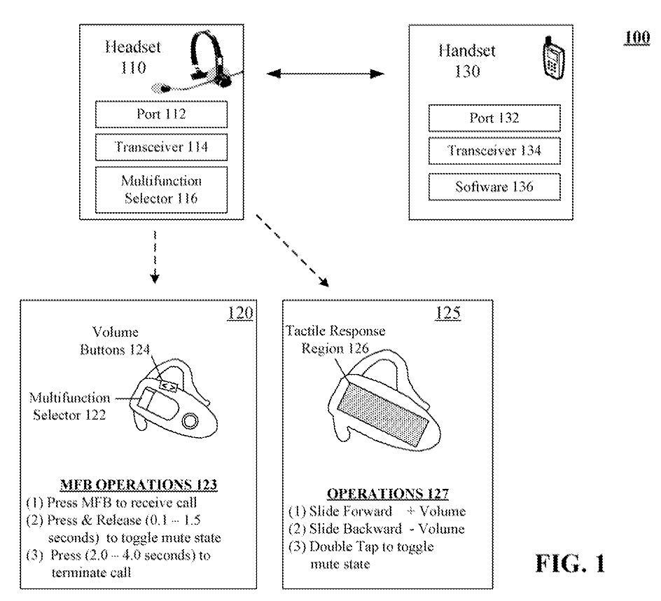

FIG. 1 is a schematic diagram of a system 100 of a mobile communication device which is able to change a mute state of a voice call using a multifunction selector of a headset 110. The headset 110 can include an earpiece and a microphone that permit a wearer to use the handset 130 in a hands free mode. In one embodiment, the headset 110 can be connected to the handset 130 via a wire that connects port 112 and port 132. In another embodiment, the headset 110 can be wirelessly connected to the handset 130 via transceiver 114 and transceiver 134. For example, a BLUETOOTH link can be used to connect headset 110 and handset 130. Appreciably, BLUETOOTH is an industrial specification for wireless personal area networks (PAN), which is also known as IEEE 802.15.1. As used herein, the term BLUETOOTH is used generically to include any PAN connection based upon or derived from the IEEE 802.15.1 specification. The invention is not limited to BLUETOOTH wireless headsets 110 and any wireless communication protocol can be utilized. For example, the headset 110 can utilize 900 MHz, 1.9 MHz, 2.4 GHz, 5.8 GHz, and other wireless frequencies/technologies to connect to the handset 130.

In system 100, the handset 130 can be any variety of mobile communication devices, which will commonly be a mobile telephone. Different communication modes can be available to handset 130, which can include telephone modes, two-way radio modes, instant messaging modes, email modes, video telecommunication modes, co-browsing modes, interactive gaming modes, image sharing modes, and the like. The handset can be a mobile telephone, a Voice over Internet Protocol (VoIP) phone, a two-way radio, a personal data assistant with voice capabilities, a mobile entertainment system, a computing tablet, a notebook computer, a wearable computing device, and the like. The headset 110 can be used to send/receive speech interactions for communication sessions involving handset 130. The headset 110 can also issue voice commands to speech enabled applications executing on handset 130 and can receive speech output generated by the speech enabled applications.

A user can handle multifunction selector 116 to convey a mute toggle request to handset 130. The request is conveyed to software 136 in the handset 130. The software 136 can mute/unmute the microphone of the headset 110. The multifunction selector 116 can be associated with controlling multiple different functions.

In one embodiment, the headset 110 and handset 130 can be explicitly configured at a time of manufacture to enable a mute toggle capability from the headset 110. In another embodiment, the headset muting capability can be a software 136 retrofit performed to add a muting capability to an existing headset 110/handset 130 combination. For example, a software retrofit or upgrade can be made to handset 130 to permit selections made via headset 110 to have a new and different meaning. For instance, before an upgrade, a multifunction selector 116 can control on/off states. After the upgrade of software 136, the multifunction selector 116 can control mute on/mute off states as well as on/off states.

One implementation of headset 110 is shown as headset 120. Headset 120 can include a multifunction selector 122 and one or more volume selectors 124. Operations 123 of the multifunction selector can allow incoming calls to be accepted, can allow a current call to be terminated, and can allow a mute state to be toggled. For example, an incoming call can be signaled by an audible alert via the earpiece of the headset 120, which can be accepted by pressing the selector 122 to receive the incoming call. In another example, during a call, selector 122 can be pressed (e.g., short press) to toggle the mute state of the microphone of headset 120. A short press can, for instance, be a press of between 0.1 and 1.5 seconds. In still another example, during a call, selector 122 can be pressed (e.g., long press) to terminate the call. A long press can, for instance, be a press between 2.0 and 4.0 seconds.

Another implementation of headset 110 is shown as headset 125. Headset 125 can include a tactile response region 126. The tactile response region can respond to sliding and tapping inputs. In particular configurations, use of region 126 can be superior to using selectors, as selectors can be smaller and hard for a user to quickly and accurately manipulate. Tactile response region 126 can also be more easily overloaded with functions, since different user motions along region 126 can be associated with different functions.

In one arrangement, the tactile response region 126 can include a laminate switching mechanism. The laminate switching mechanism can include multiple layers of substrate that are laminated together. The laminate switching mechanism can detect tactile input or pressure applied to the region 126. A force sensing resistor (FSR) is one example of a laminate switching mechanism. Another example of a laminate switching mechanism can include a force sensing capacitor (FSC). Any technology consisting of laminating layers together to sense sliding and tapping motions can be used by the laminate switching mechanism.

The tactile response region 126 can accept numerous different types of input associated with different mobile telephone operations 127. In one configuration, sliding a finger forward along the region 126 can increase volume. Sliding a finger backwards along region 126 can decrease volume. Double tapping region 126 can toggle a mute state.

Operations 123 and 128 are for illustrative purposes only and are not intended to be limiting. For example, it is contemplated that a mute state can be toggled by performing a sliding motion along region 126 in a different configuration of headset 125.

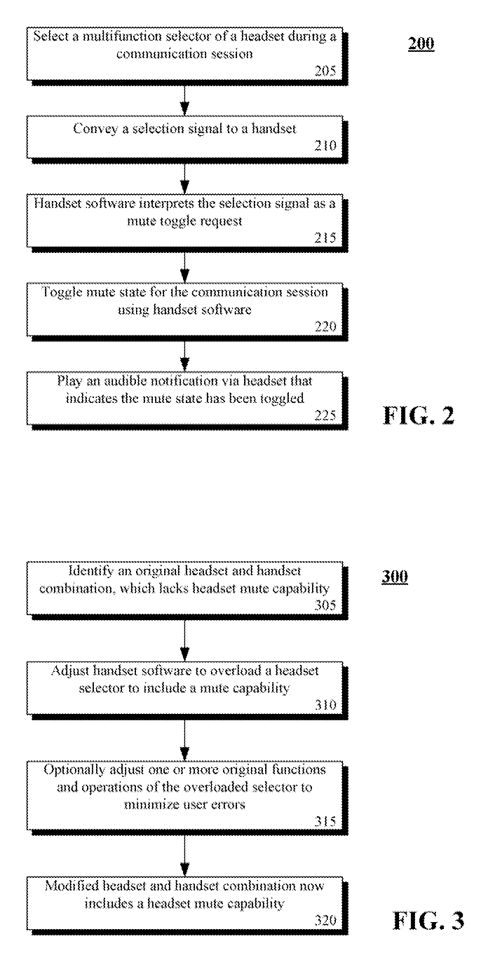

FIG. 2 is a flow chart of a method 200 for changing a mute state from a headset in accordance with an embodiment of the inventive arrangements disclosed herein. The method 200 can be performed in a context of system 100.

Method 200 can begin in step 205, where a user can select a multifunction selector of a headset during a communication session. The headset can be a wireless headset that is linked to a handset. In step 210, a selection signal can be conveyed to the handset that corresponds to the user selection. In step 215, handset software can interpret the selection signal as a mute toggle request. In step 220, a mute toggle state of the current communication session can be toggled using the handset software. This can cause the headset microphone to be muted. In step 225, an audible notification can be played via an earpiece of the headset to indicate that the mute state has been toggled. The audible notification can be a particular tone, or a series of beeps that indicate a change in the mute state. In one embodiment, intermittent audible notifications can be conveyed via the headset when the headset is muted to remind the user of this condition.

FIG. 3 is a flow chart of a method 300 for adding a muting capability to a headset in accordance with an embodiment of the inventive arrangements disclosed herein. Method 300 can begin in step 305, where an original headset and original handset combination can be identified. This original combination can lack a headset muting capability. In step 310, headset software can be adjusted to overload a headset selector to include the mute capability. In step 315, one or more original functions and operations of the original selector can be adjusted to minimize user errors. For example, in the original system a selection and release of a multifunction selector of a wireless headset can terminate a current call. Step 310 can overload this function, as shown for headset 120. In step 320, a modified headset and handset combination can include a headset mute capability. Method 300 can be performed before or after a sale of the original headset and/or the original handset. For example, a downloadable flash upgrade can modify software in the original handset to add the headset muting capability described herein.

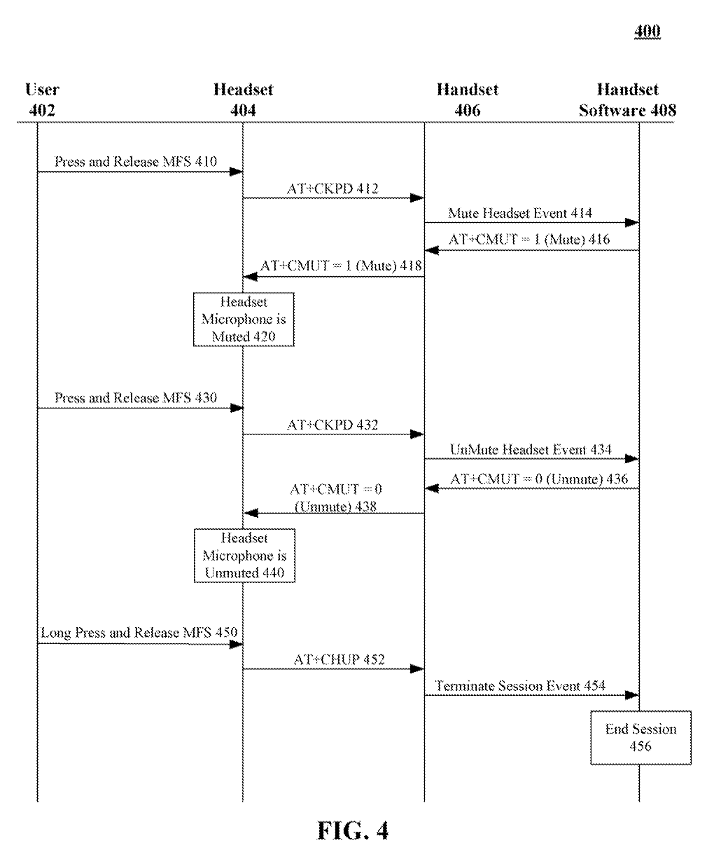

FIG. 4 is a signaling diagram 400 for performing muting actions via a headset in accordance with an embodiment of the inventive arrangements disclosed herein. Although the muting actions as shown are for headset 120 of FIG. 1, the concepts expressed herein can be easily modified for other contemplated configurations, such as headset 125.

Diagram 400 includes a user 402, a headset 404, a handset 406, and handset software 408. Diagram 400 assumes an initial state where the user 402 is engaged in a communication session. In step 410, the user 402 can press and release a multifunction selector (MFS) of a headset. This causes an attention signal 412 associated with pressing the selector (AT+CKPD) to be sent to handset 406. Signal 412 can trigger a mute headset event 414, which is detected by software 408. This event results in a mute control command 416 (AT+CMUT=1) to be conveyed to handset 406, which routes it as command 418 to headset 404. The headset microphone can be muted 420 when command 418 is received.

When a user wishes to unmute the microphone, he/she can press and release the MFS 430, which again sends an attention signal 432 for a selector press (AT+CKPD) to handset 406. In response to signal 432, an unmute headset event 434 can fire, which the software 408 can detect. Software 408 can convey an unmute command 436 (AT+CMUT=0) to the handset 406, which is routed 438 to headset 404. The headset microphone can be unmuted 440 responsive to command 438.

When a user wishes to terminate a call, he/she can input a long press and release of the MFS 450. This results is a signal 452 being sent to handset 406, which fires a terminate session event 454. The software 408 can detect this event 454 can end 456 the current communication session.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for users to control mobile communication handset options using headset controls comprising:
selecting a multifunction selector of a headset during a communication session;
conveying a mute toggle request to a mobile communication device handset; and
software within the handset toggling a mute state for the communication session.

2. The method of claim 1, further comprising:
playing an audible notification via the headset to indicate the mute state has been toggled.

3. The method of claim 1, wherein the multifunction selector is an overloaded selector also associated with accepting a call, and terminating a call, wherein a selection of the multifunction selector for a first duration occurring during the communication session toggles the mute state, wherein a selection of the multifunction selector for a second duration occurring during the communication session terminates the communication session, and wherein the second duration is longer than the first duration.

4. The method of claim 3, wherein the second duration is greater than two seconds, and wherein the first duration is less than one second.

5. The method of claim 1, wherein the headset comprises three distinct selectors, one of which is the multifunction selector, the other two selectors controlling volume.

6. The method of claim 1, wherein the headset is a wireless headset, and wherein the multifunction selector is an overloaded selector that accepts a call, terminates a call, and that changes a mute state of the communication session.

7. The method of claim 6, wherein the multifunction selector also adjusts volume.

8. The method of claim 1, wherein the multifunction selector is a laminate switching mechanism, and selecting step using an input to the laminate switching mechanism to initiate the mute toggle request.

9. The method of claim 8, wherein said input is a swiping motion of a finger along the laminate switching mechanism.

10. The method of claim 8, wherein swiping a finger along the laminate switching mechanism in one direction increases volume, wherein swiping a finger along the laminate switching mechanism in an opposite direction decreases volume.

11. The method of claim 10, wherein the input to laminate switching mechanism associated with a mute state toggle is a double tap.

12. The method of claim 1, wherein the headset is a wireless headset.

13. The method of claim 1, further comprising:
identifying an original headset and an original mobile communication device handset, wherein the original headset lacks a mute state toggle capability; and
modifying software of the mobile communication device handset to interpret a particular section from a multifunction selector as a request to toggle a mute state of a current communication session, wherein said headset of claim 1 is the original headset, and wherein said mobile communication device handset of claim 1 is the original mobile communication device handset including software modified in accordance with the modifying step.

14. The method of claim 1, wherein the headset is a standardized headset compatible with a plurality of different mobile communication device handsets, wherein at least one of a plurality of handsets is the mobile communication device handset that receives the mute toggle request in the conveying step, and wherein at least one of the plurality of handsets includes software configured to interpret the mute toggle request as a request to terminate the communication session.

15. A mobile communication system comprising:
a headset including a multifunction selector configured to control accepting a call, terminating a call, and adjusting a mute state of a call; and
a mobile telephone handset configured to be communicatively linked to the headset through a wireless connection, said handset including software that receives input from the headset, wherein said software adjusts a mute state for a communication session responsive to receiving a user selection of the multifunction selector during the communication session.

16. The system of claim 15, wherein the multifunction selector is an overloaded selector that also accepts a call and terminates a call.

17. The system of claim 15, wherein the multifunction selector is an overloaded selector that also increases and decreases volume.

18. The system of claim 15, wherein the multifunction selector is a laminate switching mechanism.

19. A mobile telephone system comprising:
a wireless headset including a tactile response region, wherein said tactile response region is a region of overloaded functionality, wherein selecting a particular desired function associated with the tactile response region is dependent upon a manner in which a user utilizes the tactile response region, one such manner including swiping a finger along the region in a particular direction and tapping the tactile response region; and
a mobile telephone handset configured to be communicatively linked to the headset through a wireless connection, said handset including software that receives input from the headset, wherein said software adjusts a mute state for a communication session responsive to receiving a user input via the tactile response region in a predetermined manner associated with the function that toggles the mute state for the communication session.

20. The system of claim 19, wherein the tactical response region includes a laminate switching mechanism, and wherein the overloaded functionality includes at least one of a function to change volume and a function to change a call connection state.
